(19) United States
(12) Patent Application Publication
(10) Pub. No.: US 2006/0087650 A1
(43) Pub. Date: Apr. 27, 2006

(54) Cuvette holder for spectrophotometers

(76) Inventor: Thomas Y. Shen, Taipei (TW)

Correspondence Address: BIRCH STEWART KOLASCH & BIRCH, PO BOX 747, FALLS CHURCH, VA, 22040-0747, US

(21) Appl. No.: 10/968,927

(22) Filed: Oct. 21, 2004

(51) Int. Cl. G01N 21/01

(52) U.S. Cl. 356/244

(57) ABSTRACT

A cuvette holder for spectrophotometers to hold various types of test tubes/cuvettes includes a dock which has three housing spaces that may form different combinations of capacity to accommodate different sizes of test tubes/cuvettes. Five standard test cuvettes of different specifications may be held in this holder fixed inside a spectrophotometer to perform test and analysis. There is no need to change a specific holder to mate different test cuvettes as the conventional technique does. Hence tests can be done much conveniently at a low cost.

### FIELD OF THE INVENTION

The present invention relates to a cuvette holder of test cuvette used on a spectrophotometer.

### BACKGROUND OF THE INVENTION

Spectroscopy is an important analysis method applied widely in scientific research, production, quality control and the like. Through transmission absorption spectroscopy, fluorescence or Raman spectroscopy, single wavelength radiation may be obtained. As the modern spectrophotometer covering a wide range of spectra (UV-VIS-IR), having a high spectrum differentiating power (0.001 nm), capable of performing automatic wavelength scanning, and providing a comprehensive computer control function, it may be easily coupled with other peripheral equipments to become a high performance automatic test system. Thus a computerized, fully automatic scanning spectrophotometer by diffraction grating has become a preferred choice in spectrum research.

The conventional spectrophotometer is a measurement instrument used in the research of compound structure and routine application analysis. A testing sample usually is contained in a cuvette. And the cuvette is held in a mating holding dock fixed inside the cell compartment of the spectrophotometer. Light with selected wavelength exiting from the monochromator passes through the sample in the test cuvette, and a plurality of parameters (such as the light pass length of cuvette and sample concentration) are applied. After measurement, the light transmission percentage of the sample can be obtained and the digitized result is shown on a display screen. The composition percentage of the common cosmetics or perfumes is usually analyzed by the spectrophotometer for downstream processing. The structure of the commonly used cuvette holder for spectrophotometer now on the market is described as follow:

To match standard cuvettes for various types of testing compounds or industries, many types of cuvette holder have been developed. Each aims to mate a specific cuvette. Hence users have to select a suitable cuvette and cuvette holder for a specific sample, then loads into a spectrophotometer to make measurement. Such an approach not only increases the cost, the cuvette holder has to be purchased anew for analyzing a different testing compound. But it is also inconvenient and not environment friendly. There is still space for improvement.

### SUMMARY OF THE INVENTION

The primary object of the present invention is to solve the aforesaid shortcoming. The present invention provides a cuvette holder for spectrophotometers to facilitate test analysis at a lower cost.

The cuvette holder for spectrophotometers according to the invention includes a dock having three housing spaces.

The housing spaces in the dock may be coupled to form different combinations of holding capacity to accommodate five standard test cuvettes of varying specifications to be loaded into a spectrophotometer to perform test and analysis.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the present invention.

FIG. 2 is a sectional view of the present invention.

FIG. 3 is a schematic view of a first embodiment of the present invention.

FIG. 4 is a schematic view of a second embodiment of the present invention.

FIG. 5 is a schematic view of a third embodiment of the present invention.

FIG. 6 is a schematic view of a fourth embodiment of the present invention.

### DETAILED DESCRIPTION OF THE PREFERRED EMBODIMENTS

The present invention adopts a simple design concept to provide a cuvettes holder for holding testing compounds to be loaded in a spectrophotometer. Therefore during analysis, there is no need to allocate an another cuvette holder compatible to the test cuvette being used. It is more convenient and the cost may also be reduced.

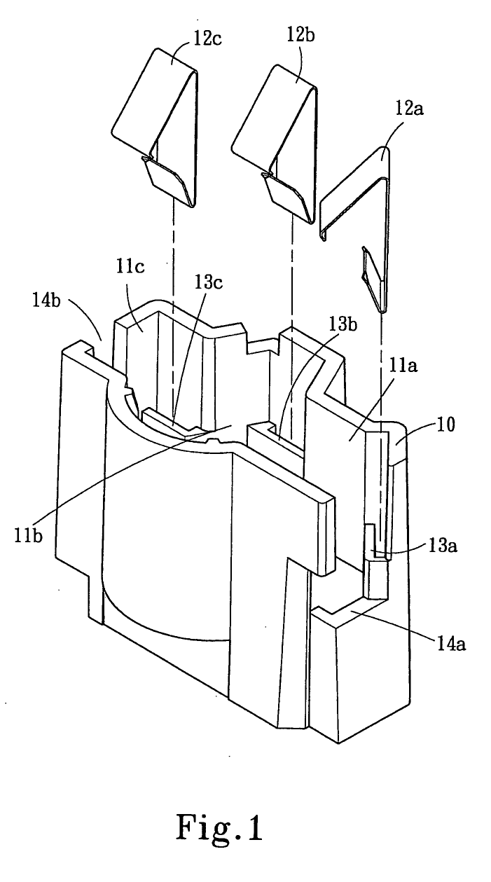

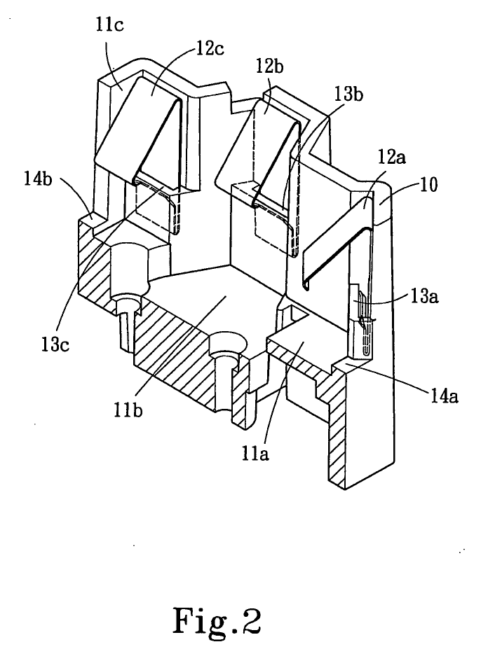

Please referring to FIGS. 1 and 2, the cuvette holder according to the invention includes a dock 10 (preferably made from plastics and integrally formed by molding). The dock 10 has three housing spaces 11a, 11b and 11c that are coupled respectively with a coupling member 12a, 12b and 12c (preferably made of metal). Beside the housing spaces 11a, 11b and 11c, there are respectively a trough 13a, 13b and 13c to hold one end of the coupling member 12a, 12b and 12c in a loosely manner. On two sides of the dock 10, there are slots 14a and 14b to enable the light generated by a monochromator (not shown in the drawings) to pass through. The housing spaces 11a, 11b and 11c may be coupled in different combinations to accommodate various types of cuvettes.

By means of the construction set forth above, five standard test cuvettes (not shown in the drawings) of different specifications may be held in this cuvette holder fixed in the spectrophotometer (not shown in the drawings) to perform test and analysis. Therefore, there is no need to select a specific cuvette holder to match different types of test cuvettes. Test may be done more conveniently and the cost may be reduced.

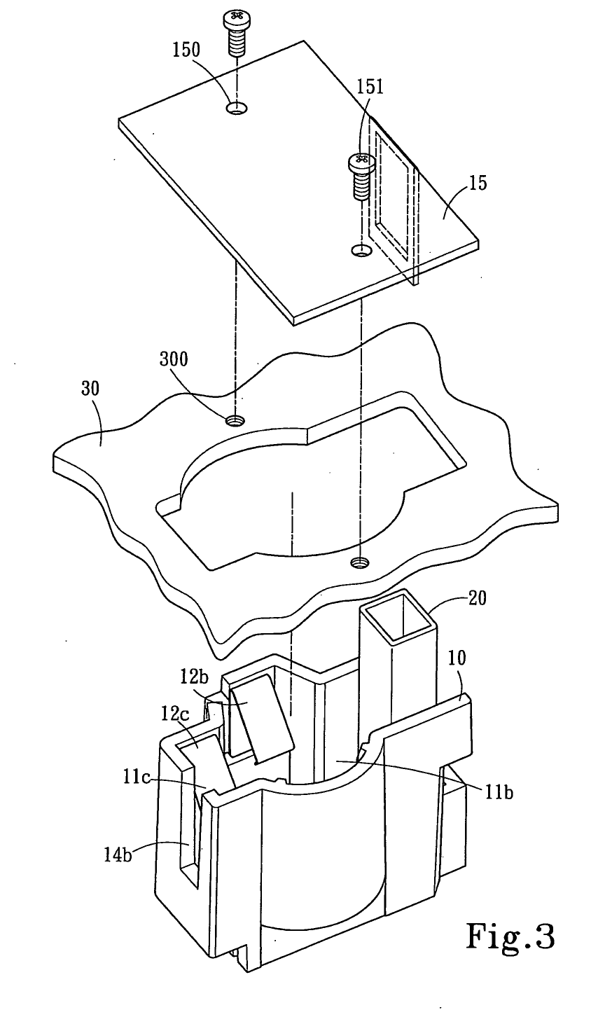

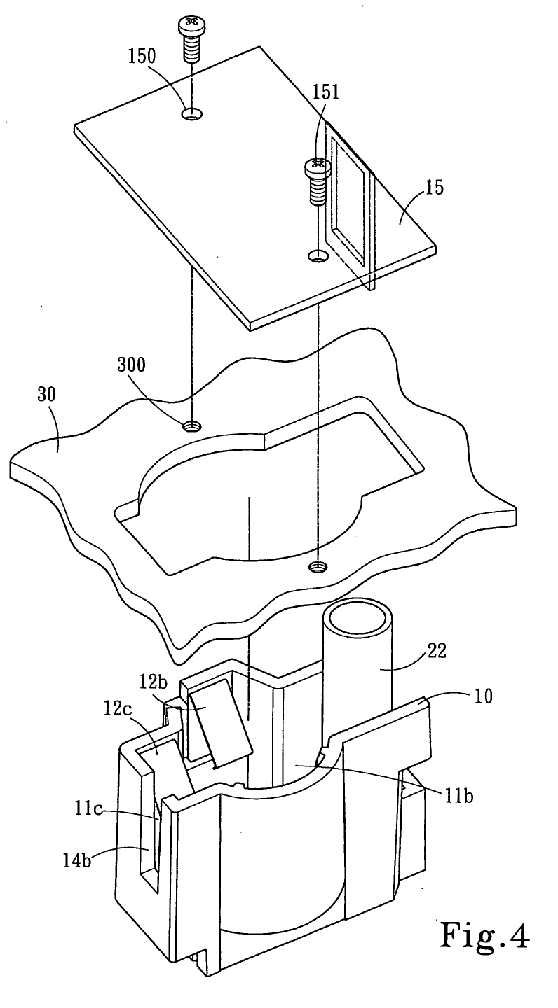

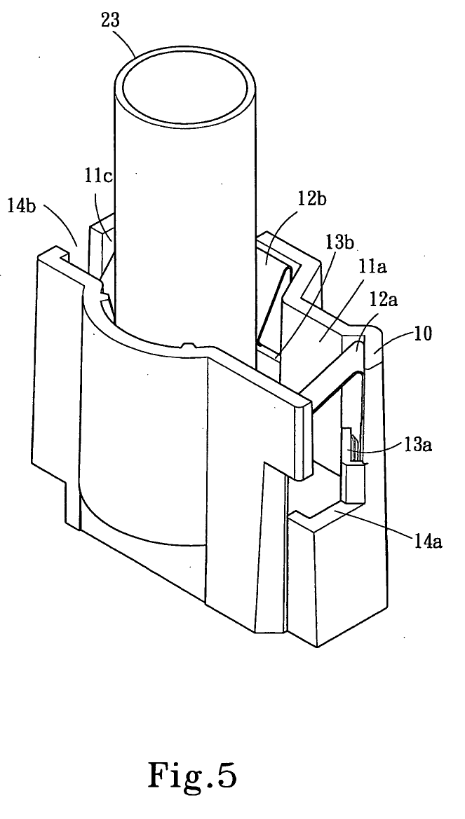

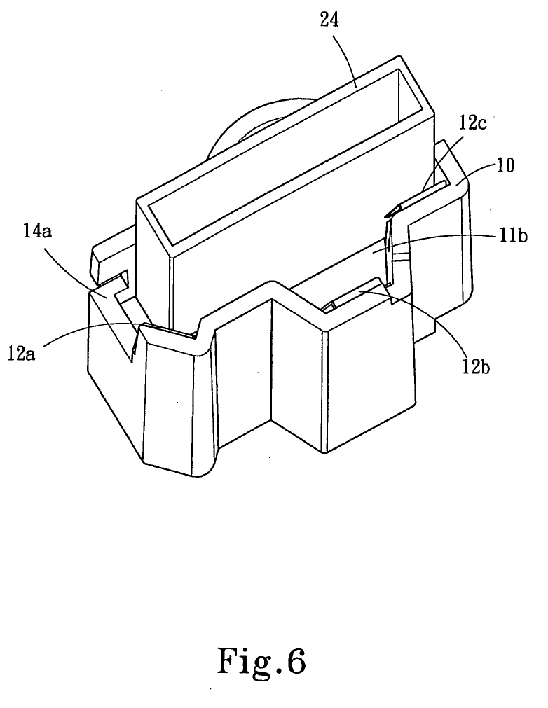

Refer to FIGS. 3 through 6 for various embodiments of the invention. As shown in the drawings, five standard test cuvettes may be used on this holder, including a square cuvette 20 with a width of 10 mm, a micro cell (not shown in the drawings) with light pass length 10 mm, a round tube 22 with a diameter of 0.5 inch, a round tube 23 with a diameter of one inch, and a rectangular test cuvette 24 with a length of 50 mm. The light of the spectrophotometer can pass through the slots 14a and 14b and the center of the test cuvette to measure the composition percentage of a compound (not shown in the drawings) held therein. The first and second embodiments (FIGS. 3 and 4) contain respectively the square cuvette 20 of 10 mm width and a round tube 22 of 0.5 inch diameter. The dock 10 is coupled with a mating lid 15 to anchor these standard cuvettes. The lid 15 has a plurality of fastening holes 150 corresponding to apertures 300 formed on a board 300 located in the cell compartment of the spectrophotometer (not shown in the drawings) that are coupled by a plurality of fastening elements 151 to fasten the dock 10 to the spectrophotometer (not shown in the drawings).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A cuvette holder of a spectrophotometer for holding a plurality of test cuvettes used in the spectrograph, comprising:
a dock having three housing spaces to form combinations of different capacity to hold cuvettes.

2. The cuvette holder for a spectrophotometer of claim 1, wherein the dock has a trough formed respectively on one side of the housing spaces.

3. The cuvette holder for a spectrophotometer of claim 2, wherein the housing spaces are respectively coupled with a coupling member which has one end wedged in the trough.

4. The cuvette holder for a spectrophotometer of claim 3, wherein the coupling members are made of metal.

5. The cuvette holder for a spectrophotometer of claim 1, wherein the dock has two slots formed on two sides corresponding to each other to be passed through.

6. The cuvette holder for a spectrophotometer of claim 1, wherein the dock is integrally formed.

7. The cuvette holder for a spectrophotometer of claim 1, wherein the dock is coupled with a mating lid for anchoring test cuvettes.

8. The cuvette holder for a spectrophotometer of claim 7, wherein the lid has a plurality of fastening apertures corresponding to the spectrophotometer to receive a plurality of fastening elements to fasten the dock to the spectrophotometer.

9. The cuvette holder for a spectrophotometer of claim 1, wherein the dock is made from plastics.

10. The cuvette holder for a spectrophotometer of claim 1, wherein the test cuvette is a square cuvette having a width of 10 mm.

11. The cuvette holder for a spectrophotometer of claim 1, wherein the cuvette is a micro cell with light pass length 10 mm.

12. The cuvette holder for a spectrophotometer of claim 1, wherein the cuvette is a round tube having a diameter of 0.5 inch.

13. The cuvette holder for a spectrophotometer of claim 1, wherein the cuvette is a round tube having a diameter of one inch.

14. The cuvette holder for a spectrophotometer of claim 1, wherein the cuvette is a rectangular cell having a length of 50 mm.
